(19) United States
(12) Patent Application Publication
(10) Pub. No.: US 2023/0013318 A1
(43) Pub. Date: Jan. 19, 2023

(54) SHEATH BEAM STRIPPER AND PRODUCTION METHOD THEREOF

(71) Applicant: BILKENT UNIVERSITESI (UNAM) ULUSAL NANOTEKNOLOJI ARASTIRMA MERKEZI, Ankara (TR)

(72) Inventors: Bulend ORTAC, Ankara (TR); Bartu SIMSEK, Ankara (TR); Ozan AKTAS, Ankara (TR)

(73) Assignee: BILKENT UNIVERSITESI (UNAM) ULUSAL NANOTEKNOLOJI ARASTIRMA MERKEZI, Ankara (TR)

(21) Appl. No.: 17/784,526

(22) PCT Filed: Dec. 11, 2020
(86) PCT No.: PCT/TR2020/051273

§ 371 Date: Jun. 10, 2022

(30) Foreign Application Priority Data
Dec. 13, 2019 (TR) 2019/20220

(51) Int. Cl. G02B 6/44

(52) U.S. Cl. CPC G02B 6/4486

(57) ABSTRACT

The present invention relates to a sheath beam stripper (1) which discharges pumping light that cannot be absorbed by active fiber in high-power fiber laser systems, from fiber optic cable; and production method (100) thereof

### TECHNICAL FIELD

The present invention relates to a sheath beam stripper which discharges pumping light that cannot be absorbed by active fiber in high-power fiber laser systems, from fiber optic cable; and production method thereof.

### BACKGROUND OF THE INVENTION

In all fiber laser systems, a certain ratio of pumping light transferred from pumping diodes to active fiber by means of combinary (fiber optic beam combiner) cannot be absorbed by active atoms included in fiber core and it continues to proceed in the sheath region of the fiber. Absorption ratio of pumping light is directly related to geometry and additive ratios of active fiber. The fact that laser signal and non-absorbable pumping light exit leave the fiber laser outlet together reduces the quality of the laser beam and causes the optical elements or materials that will be integrated to the outlet pan of the fiber laser to be damaged. A component of sheath beam stripper is required in order to get free from this effect.

The International patent document no. WO2008088336, an application in the state of the art, discloses coating all or part of one or more surfaces of a shaped article with a covering material. The article of manufacture shaped or to be coated may be fiber optic cable. The shaped product can be coated by methods such as electrolysis coating, vapor deposition, vacuum evaporation, sputtering, or brushing spraying, overmolding, lamination and roller coating. The thermoplastic polymers used in coating have high temperature resistance, good electrical properties, and good hydrolytic stability like polysulfones, poly(ether sulfone)s and poly(phenylene ether sulfone)s.

### SUMMARY OF THE INVENTION

An objective of the present invention is to realize a sheath beam stripper which discharges pumping light that cannot be absorbed by active fiber in high-power fiber laser systems, from fiber optic cable; and production method thereof.

Another objective of the present invention is to realize a sheath beam stripper which can scatter light better than thin films, and production method thereof.

Another objective of the present invention is to realize a sheath beam stripper which is used as light stripper, and production method thereof.

### DETAILED DESCRIPTION OF THE INVENTION

“Sheath Beam Stripper and Production Method Thereof” realized to fulfil the objectives of the present invention is shown in the figures attached, in which.

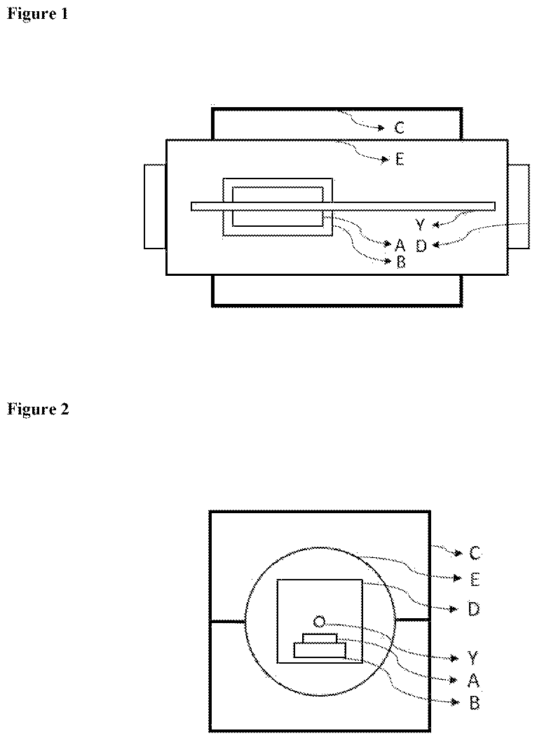

FIG. 1 is a top view of a thermoplastic polymer which is inserted onto the metal frame inside the tube connected to the inventive vacuum pump, before evaporation.

FIG. 2 is a sectional view of a thermoplastic polymer which is inserted onto the metal frame inside the tube connected to the inventive vacuum pump, before evaporation.

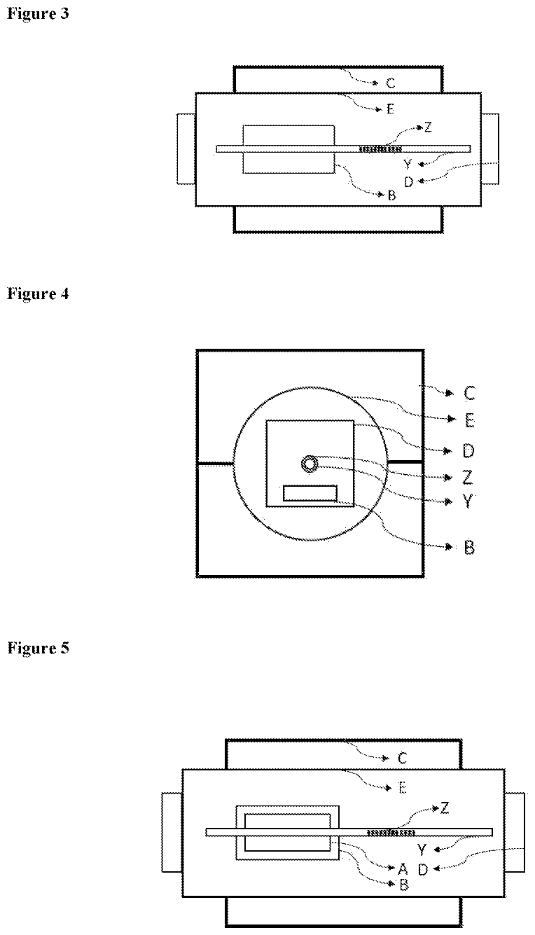

FIG. 3 is a top view of a thermoplastic polymer which is inserted onto the metal frame inside the tube connected to the inventive vacuum pump, after evaporation.

FIG. 4 is a sectional view of a thermoplastic polymer which is inserted onto the metal frame inside the tube connected to the inventive vacuum pump, after evaporation.

FIG. 5 is a view of equipment whereby production of the inventive sheath beam stripper is made.

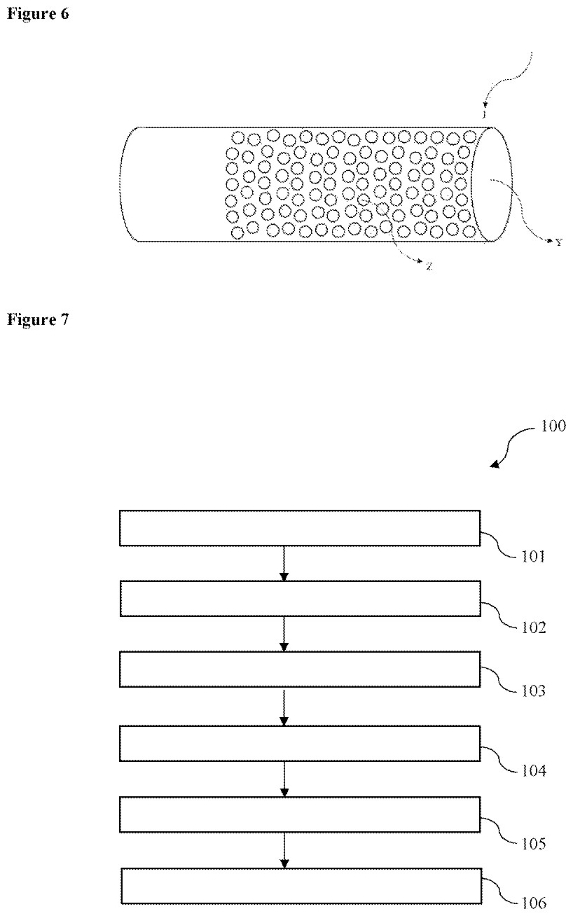

FIG. 6 is a view of the sheath beam stripper which is obtained by coating the polymer onto the inventive fiber optic cable in islets.

FIG. 7 is a flow chart of the inventive method.

The components illustrated in the figures are individually numbered, where the numbers refer to the following:
1. Sheath beam stripper

Production method (100) of a sheath beam stripper (1) which is used as the inventive beam stripper comprises steps of:
inserting the thermoplastic polymer (A) in film form onto the aluminium frame (B) (101);
putting the aluminium frame (B) whereon the thermoplastic polymer film (A) is located, into a tube (E) that is heated by the thermal oven (C) and connected to the vacuum pump (D)(102);
inserting the fiber optic cable (Y), outer surface of which will be coated, into the thermal oven (C) (103);
switching the thermoplastic polymer film (A) into a vapour phase by keeping it at a certain temperature inside the thermal oven (C)(104);
intensifying the thermoplastic polymer (A) that is switched into a vapour phase inside the oven (C) and resistant to high temperatures, by reducing the temperature inside the oven (C) (105); and
obtaining the sheath beam strippers (1) by coating the thermoplastic polymer (A), which is intensified in the form of water droplets in nano or micro sizes, onto the fiber optic cable (Y)(106).

In the inventive method (100), the thermoplastic polymer (A) which is used at the step of inserting the thermoplastic polymer (A) in film form onto the aluminium frame (B) (101) is preferably polyether sulfone (PES).

In the inventive method (100), at the step of switching the thermoplastic polymer film (A) into a vapour phase by keeping it at a certain temperature inside the thermal oven (C) (104), a temperature range of 290-310° C. is provided inside the thermal oven (C) and transition to a vapour phase occurs after waiting for 25-35 minutes.

The sheath beam stripper (1) obtained by the inventive method (100) is formed by virtue of the fact that the polymer holds on to the surface in islets (Z) like water drops on hydrophobic surfaces and covers an area without contacting each other and the light scatters better than thin films by means of this configuration.

The sheath beam stripper (1) obtained by the inventive method (100) aims to protect fiber against external effects externally, to increase its resistance to high temperature, and to strip the light that has a new area of usage.

Within these basic concepts; it is possible to develop various embodiments of the inventive sheath beam stripper (1) and production method thereof (100); the invention cannot be limited to examples disclosed herein and it is essentially according to claims.

1. Production method (100) of a sheath beam stripper (1) which is used as a beam stripper characterized by comprising steps of:
inserting the thermoplastic polymer (A) in film form onto the aluminium frame (B) (101);
putting the aluminium frame (B) whereon the thermoplastic polymer film (A) is located, into a tube (E) that is heated by the thermal oven (C) and connected to the vacuum pump (D) (102);
inserting the fiber optic cable (Y), outer surface of which will be coated, into the thermal oven (C) (103);
switching the thermoplastic polymer film (A) into a vapour phase by keeping it at a certain temperature inside the thermal oven (C) (104);
intensifying the thermoplastic polymer (A) that is switched into a vapour phase inside the oven (C) and resistant to high temperatures, by reducing the temperature inside the oven (C) (105); and
obtaining the sheath beam strippers (1) by coating the thermoplastic polymer (A), which is intensified in the form of water droplets in nano or micro sizes, onto the fiber optic cable (Y) (106).

2. Production method (100) of a sheath beam stripper (1) according to claim 1; characterized in that the thermoplastic polymer (A) used is polyether sulfone (PES).

3. Production method (100) of a sheath beam stripper (1) according to claim 1; characterized in that the thermoplastic polymer film (A) is provided in a temperature range of 290-310° C. inside the thermal oven (C) and it is switched to a vapour phase after being kept for 25-35 minutes.

4. A sheath beam stripper (1) which is obtained by a method according to claim 1 and formed by virtue of the fact that the polymer holds on to the surface in islets (Z) like water drops on hydrophobic surfaces and then covers an area without contacting each other and ensures that the light scatters better than thin films by means of this configuration.

5. A sheath beam stripper (1) which is obtained by a method according to claim 1, aims to protect fiber against external effects externally, to increase its resistance to high temperature, and to strip the light that has a new area of usage.
